(19) United States
(12) Patent Application Publication
(10) Pub. No.: US 2015/0066626 A1
(43) Pub. Date: Mar. 5, 2015

(54) Predicting Success Rates for Online Search Terms Based on Offline Advertising

(71) Applicant: Adobe Systems Incorporated, San Jose, CA (US)

(72) Inventors: Ayman Omar Farahat, San Francisco, CA (US); Abhishek Pani, San Francisco, CA (US)

(73) Assignee: Adobe Systems Incorporated, San Jose, CA (US)

(21) Appl. No.: 14/011,181

(22) Filed: Aug. 27, 2013

(51) Int. Cl. G06Q 30/02; G06F 17/30

(52) U.S. Cl. CPC G06Q 30/0242; G06F 17/30864
USPC 705/14.41

(57) ABSTRACT

Techniques for predicting success rates for online search terms based on offline advertising are described herein. The techniques enable marketers to determine appropriate values for online search terms based on their predicted success rates. By so doing, marketers may decide whether to pay online search engines for preferences of their website in response to a search using these online search terms.

### BACKGROUND

Online search advertising is a significant portion of many companies' marketing strategy. These companies pay search engines to present their websites preferentially, thereby driving online traffic to their websites. For example, a car manufacturer may pay a search engine to have the search engine present the car manufacturer's website first on a search-results page for searches having the online search terms: “best sports car.”

These search engines charge for these preferences, and companies are willing to pay these charges, based on averaged historic search volumes for the online search terms of interest to those companies. These averaged historic search volumes, however, are often poor indicators of future search volumes and other indicia of online success.

### SUMMARY

Techniques for predicting success rates for online search terms based on offline advertising are described herein. The techniques enable marketers to determine appropriate values for online search terms based on their predicted success rates. By so doing, marketers may decide whether to pay online search engines for preferences for their website in response to a search using these online search terms.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 illustrates an environment in which techniques for predicting success rates for online search terms based on offline advertising can be embodied.

FIG. 2 illustrates the local computing device of FIG. 1 in detail.

FIG. 3 illustrates an historic success rate for an online search term associated with an offline advertising schedule.

FIG. 4 illustrates the remote computing device of FIG. 1 in detail.

FIG. 5 is a flow diagram showing methods in an example implementation in which the techniques predict success rates based on an offline advertising schedule.

FIG. 6 illustrates a user interface having a histogram showing predicted search volumes and predicted conversions.

FIG. 7 is a flow diagram showing methods in an example implementation in which the techniques determine time-based financial values for the online search terms.

FIG. 8 illustrates an example system usable to implement the techniques described herein.

### DETAILED DESCRIPTION

### Overview

This document describes various apparatuses and techniques for predicting success rates for online search terms based on offline advertising. Various embodiments of these techniques receive an offline advertising schedule for a product, brand, or entity. With this offline advertising schedule, the techniques predict success rates for online search terms associated with the product, brand, or entity. These success rates can then be used to inform marketers as to whether or not to purchase preferences of their websites when searches using these terms are performed.

The techniques can determine, for example, that a commercial broadcast during a sporting event for a Super Streak Sports Car made by Packard Motors will increase online searches that include the terms “Sports Car,” “Packard,” or “Super Streak” by three-hundred percent at two and three days after the commercial has been broadcast. Based on this determination, car companies can determine how to value preferences provided by online search engines for these terms. Packard Motors or one of its competitors may desire to pay for these preferences due to the higher value that these preferences are predicted to garner following broadcast of this commercial.

This document now turns to an example environment in which the techniques can be embodied, after which various example methods for performing the techniques are described. Example methods may be performed in the example environment as well as other environments. Consequently, performance of the example methods is not limited to the example environment and the example environment is not limited to performance of the example methods.

### Example Environment

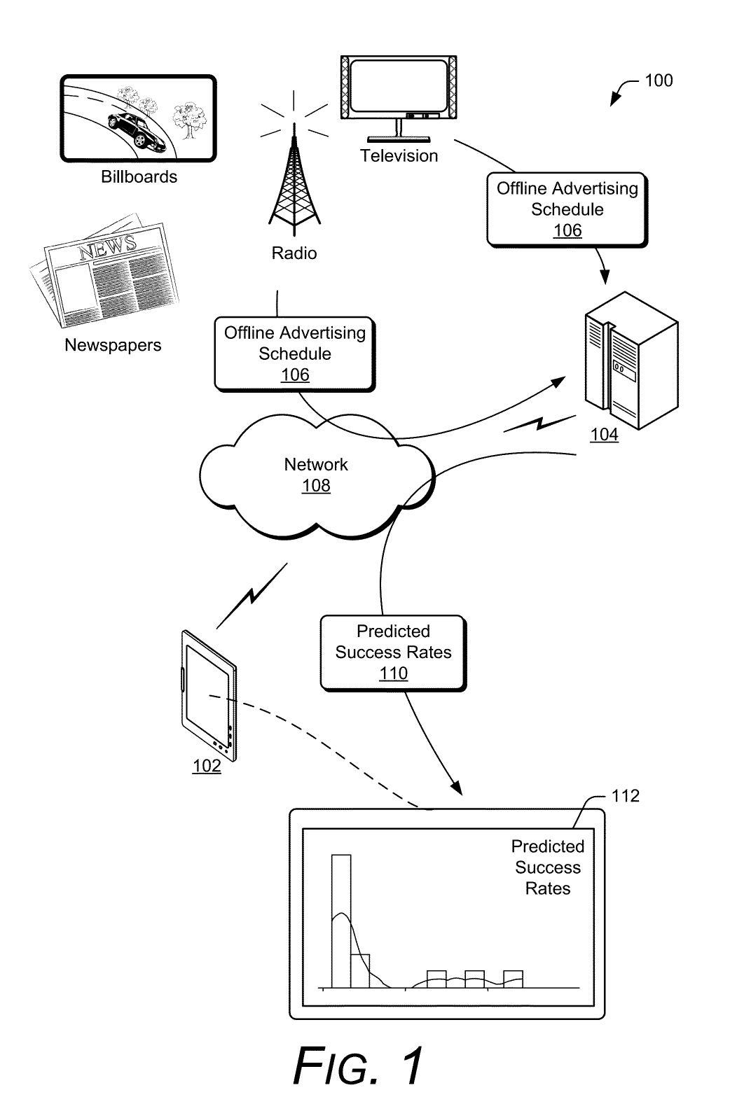

FIG. 1 illustrates an example environment 100 that is operable to employ techniques described herein. Environment 100 includes a local computing device 102, a remote computing device 104, an offline advertising schedule 106, and a network 108 through which the computing devices may communicate, each of which may be configured in a variety of ways.

Generally, remote computing device 104 receives offline advertising schedule 106, predicts success rates for online search terms based on offline advertising schedule 106, and provides predicted success rates 110 to local computing device 102. Reception of offline advertising schedule 106 is shown through electronic (e.g., network 108) and non-electronic manners through respective arrows. Provision of predicted success rates 110 is shown through network 108. Local computing device 102 may then present predicted success rates 110 through user interface 112 to better enable a marketer to decide whether or not to purchase preferences from online search engines for the online search terms.

Preferences can be purchased and vary, but are known or are predicted to increase one or more indicia of marketing success, such as preferential presentation of a company's website's link at a top of a search-results page, highlights to a link (e.g., color or animation), presentation of the company's website automatically on selecting the online search terms, providing additional information about the website near or in conjunction with the link, and so forth.

Offline advertising schedule 106 includes one or more offline ads and when the ads either have run or will run. Offline ads include advertisements that were common prior to wide adoption of the internet, web browsing, and so forth, as well as other offline manners that are recently in use. Examples of offline ads include television commercials, radio commercials, book releases, print advertisements (e.g., pamphlets, newspapers), billboards, new-store openings, and brick-and-mortar store ads, such as those on signs or in windows.

With ever-greater use of the internet, television and radio are often presented to users through computing devices, rather than simple radios or broadcast-antenna-based televisions. For the purposes of the techniques, commercials on radio and television that are provided with the aid of computing devices are considered offline advertisements so long as the commercials follow a time-based schedule that can be predicted or is known. Offline advertisements do not include advertisements provided through non-television and non-radio webpages, pop-up ads on websites, and email marketing campaigns.

Offline advertising schedule 106 can also include information about timing, repetition, a number of persons expected to be exposed to advertisements of the offline advertising schedule, or about where and how ads will be presented, such as whether the advertising is concentrated in a particular geographic location, to a cultural group, or in a politically-bounded region (e.g., a nation or province). As will be addressed below, success rates can be predicted based on this information, including to tailor predicted success rates 110 to particular groups, locations, and so forth.

Predicted success rates 110 indicate predicted or probable success in some fashion and by which a marketer may make more-informed decisions about his or her company's marketing through search engines. One indicator of possible success is search volume, another is click-through rate, and another is conversion rate. Search volume indicates a number of times the online search terms are entered into search engines. The more often that these online search terms are searched, the more often a company's webpage has an opportunity to be seen, opened, and a purchase or a positive impression made as well as other positive outcomes. Click-through rates measure how often a link to a website is selected. Conversion rates measure how often a purchase is made, a positive impression is made, or is assumed to be made, or some other positive outcome, such as purchase of a pair of shoes, a user's watching a video explaining a product, or a user completing a survey about his or her political opinions of interest to the marketer's company.

Alternatively or in addition to use of offline advertising schedules to predict success rates for online search terms, remote computing device 104 may predict success rates for online advertisements based on offline advertising schedule 106 and provide predicted success rates 110 for those online advertisements. These online advertisements can be for various websites and presented in various manners currently used for presenting advertisements online, including advertisements on the online search engines. On receipt of these predicted success rates 110, local computing device 102 may present predicted success rates 110 through user interface 112 to better enable a marketer to decide whether or not to purchase advertisements on online search engines (or other websites). When used in combination, a marketer may determine, based on predicted success rates 110 for both online search terms and online advertisements, to purchase preferences for online search terms and to display advertisements on the online search engine's results page, for example.

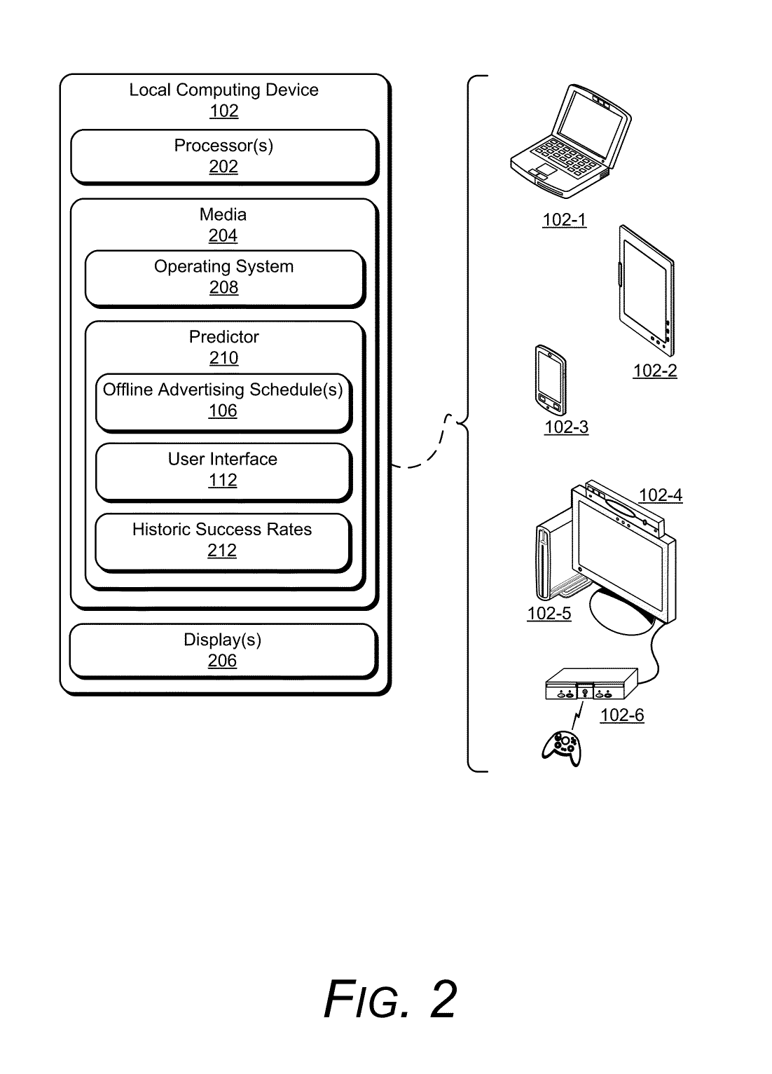

FIG. 2 illustrates an example embodiment of local computing device 102 of FIG. 1, which is illustrated with six examples devices: a laptop computer 102-1, a tablet computer 102-2, a smart phone 102-3, a set-top box 102-4, a desktop computer 102-5, and a gaming device 102-6, though other computing devices and systems, such as servers and netbooks, may also be used.

Local computing device 102 includes or has access to computer processor(s) 202, computer-readable storage media 204 (media 204), and one or more displays 206, four examples of which are illustrated in FIG. 2. Media 204 includes an operating system 208 and predictor 210. Predictor 210 includes or has access to one more offline advertising schedules 106, user interface 112, and, in some cases, historic success rates 212.

User interface 112 presents predicted success rates 110 and may enable selection to purchase preferences and/or advertisements from online search engines. Ways in which user interface 112 may act are set forth in greater detail in the Methods section below.

Predictor 210 predicts success rates for online search terms and/or online advertisements based on offline advertising schedule 106. This predicting is for online search terms or advertisements associated with a same or similar product, brand, entity or other relationship between online search terms or advertisements and the product, brand, or entity advertised in offline advertising schedule 106. Similarities between products (or brands or manufacturers) can be based on them being in a same class, category, or type, such as ads for a sports car being similar to a sedan based on both be of a same category (automobile). Other example classes, categories, and types include kitchen utensils, travel services, car tires, comedy television shows, vacation packages, action movies, women's dress shoes, men's athletic clothing, kid's toys, and so forth.

The association of online search terms and an offline advertisement does not have to include similarities, as in some cases success rates are conversely associated with offline advertising, such as offline advertisements for skin cancer treatments negatively affecting online search terms associated with vacations to sunny beaches. Also, these other relationships can be for products or services that are not similar but have a relationship shown to predict success (or failure) of online search terms, such as offline advertisements for Spanish lessons affecting online search terms associated with vacations to Cabo San Lucas, Mexico and Santiago, Chile.

In another example, assume that offline advertising schedule 106 is for a first product (peanut butter) having a first brand (Jim's Homemade Spreads) and made by a first entity (Fine Foods Inc.). In this case, predictor 210 predicts success rates for online search terms for a similar product (almond butter), similar brand (Jane's Gourmet Butters), or similar manufacturer (Best Food Products SA).

Furthermore, predictor 210 may determine which online search terms are relevant to the offline advertising schedule. Continuing the peanut-butter example, predictor 210 may determine that television ads for peanut butter affect online search terms for “almond butter,” “good fats,” “low cholesterol foods,” “hazelnut butter,” and “dark-chocolate peanuts.” These predictions can be based on historic success rates 212 and/or historic offline advertising schedules, such as many prior schedules, terms, and products mentioned in the advertisements, and analysis of online advertisements and/or search terms affected. As noted, historic success rates 212 include recorded information about success rates for the online advertisements and/or search terms.

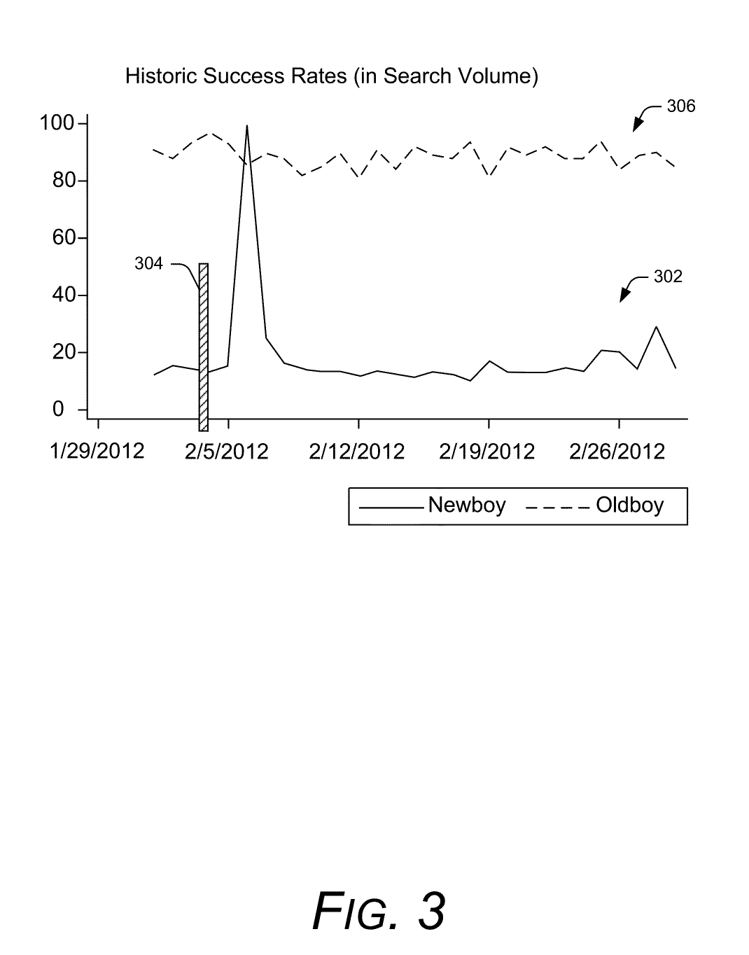

Consider, by way of example, FIG. 3, which illustrates an historic success rate 302 for an online search term “Newboy” associated with a particular offline advertising schedule for Newboy Internet Services. The offline advertising schedule associated with historic success rate 302 (here measured in search volume) is relatively short—six ads within a three-hour period (for a three-hour sporting event with a very large market share). Offline advertising schedule 304 is shown as a mark on the graph for Feb. 4, 2012. Note that historic success rate 302 is based on searches that have at least a single term—the name of the entity that was advertised, Newboy. Another historic success rate, historic success rate 306 for a competitive entity, Oldboy Internet Services, which holds a larger market share and higher general search volumes, is shown for context and can be used by predictor 210 as a set of control data.

Predictor 210 can compare future offline advertising schedules that are short and widely seen, such as another large-audience sporting event, to success rates of historic success rate 302. This, in combination with various other factors and conditions, can be used to make predictions, including use of multiple historic success rates across similar or different products, types of offline media (e.g., television, radio, billboards), and contextual considerations (e.g., type of television or radio program in which the advertisements are presented).

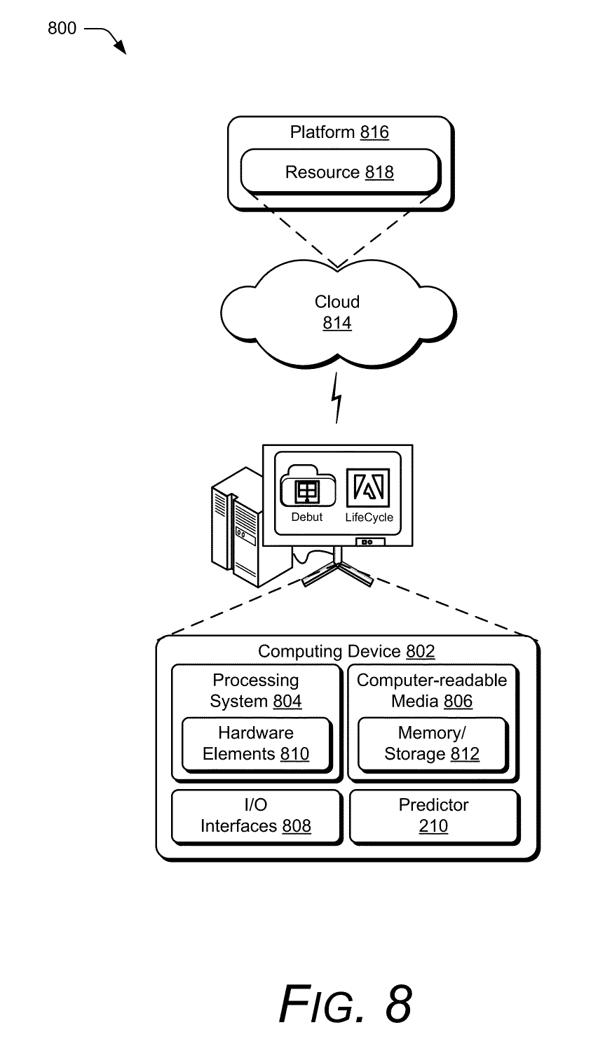

Returning to FIG. 2, local computing device 102 may be configured as a full resource device with substantial memory and processor resources (e.g., personal computers, game consoles), a mid-resource device with moderate memory and resources (e.g., a netbook), or a low-resource device with limited memory and/or processing resources (e.g., mobile devices, automobile computing devices, computers within children's toys, kitchen appliances with computing abilities). Local computing device 102 may be representative of one or a plurality of different devices, such as multiple servers utilized by a business to perform operations “over the cloud” as further described in relation to FIG. 8.

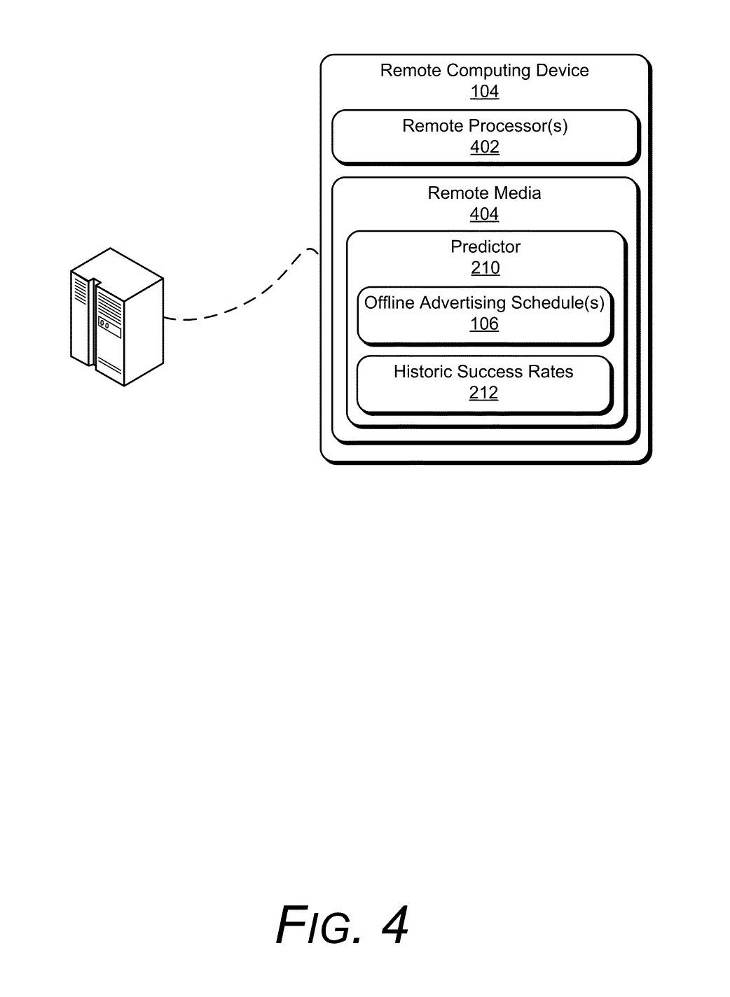

FIG. 4 illustrates an example embodiment of remote computing device 104. Remote computing device 104 is shown as a singular entity for visual brevity, though multiple devices may instead be used. Remote computing device 104 includes or has to access to remote processor(s) 402 and remote computer-readable storage media 404 (remote media 404). Remote media 404 includes or has access to, in some cases, predictor 210, offline advertising schedules 106, and historic success rates 212. Thus, the operations of predictor 210 can be performed at remote computing device 104, local computing device 102, or some combination of these or other entities.

Ways in which entities and components of FIGS. 1, 2, and 4 act and interact are set forth in greater detail below. The components illustrated for local computing device 102 and remote computing device 104 can be separate or integrated and operate as part of a web platform as described in relation to FIG. 8, for example.

### Example Methods

The following discussion describes methods that predict success rates for online advertisements and/or search terms based on an offline advertising schedule. Aspects of each of the methods may be implemented in hardware, firmware, or software, or a combination thereof. The methods are shown as a set of blocks that specify operations performed by one or more devices and are not necessarily limited to the orders shown for performing the operations by the respective blocks. In portions of the following discussion, reference will be made to FIGS. 1-4.

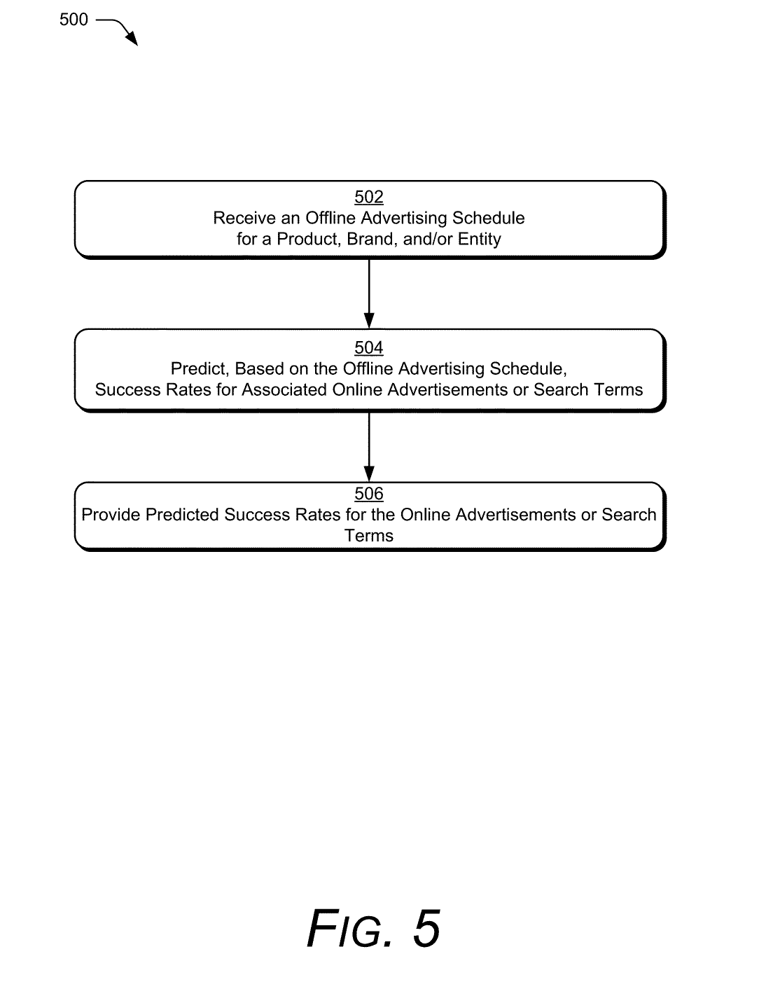

FIG. 5 depicts methods 500 in an example implementation in which the techniques predict success rates based on an offline advertising schedule. By so doing, marketers may determine whether or not to purchase search engine preferences for online search terms or advertisements.

Block 502 receives an offline advertising schedule for a product, brand, or entity. As noted in part above, the offline advertising schedule can be provided by various entities or can be retrieved or acquired. Predictor 210, for example, may retrieve offline advertising schedule 106 from a third-party market-research company, such as Kantar Group™, Nielsen Company™, IMS Health™, or Ipsos SA™, to name but a few.

Also or instead, predictor 210 may determine an offline advertising schedule, even in cases where the schedule has recently begun. Consider a case where a big sporting game has just begun and that advertising for some products is not yet publicly known. The techniques may determine, even during the first advertisement, an offline advertising schedule that may affect online search terms and related success rates. Assume that a particular advertisement is a secret until aired during the World Cup Finals or the Super Bowl, in such a case, even one offline advertisement can dramatically alter success rates of associated online advertisements and/or search terms, and thus the effectiveness of advertising costs for preferences or advertisements purchased from search engines.

Block 504 predicts, based on the offline advertising schedule, success rates for online advertisements and/or search terms associated with a same, similar, or related product, brand, or entity. Assume, for example, that predictor 210 uses historic success rate 302 shown in FIG. 3 as part of analyzing an offline advertising schedule that indicates that a motorcycle manufacturer will be advertising its products during a World Cup game that is expected to be seen by large populations in Argentina and Chile. Predictor 210 may use this offline advertising schedule and historic success rate 302 of FIG. 3 to aid in predicting success rates 110 for online search terms associated with this maker's motorcycles and made by residents of these countries.

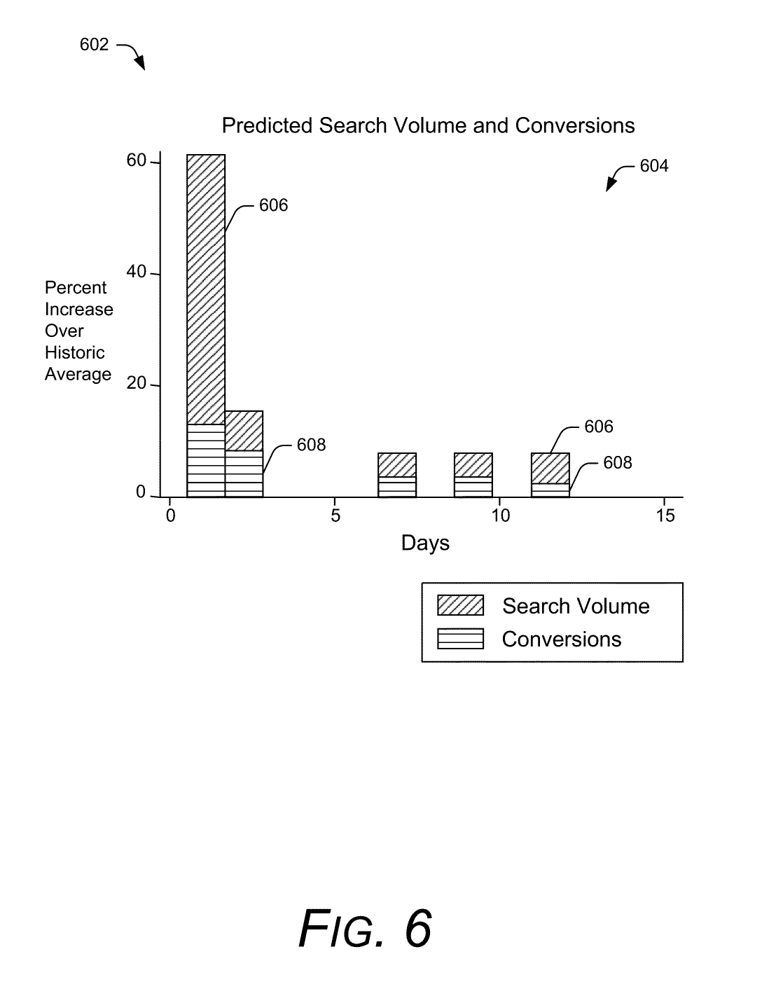

Block 506 provides the predicted success rates for the online advertisements and/or search terms. Concluding the ongoing example, consider FIG. 6, which illustrates predictor 210 providing, through presentation in a user interface 602, a histogram 604 showing predicted search volumes 606 and predicted conversions 608 for the motorcycle manufacturer (or competitor) for online searches performed by residents of Argentina and Chile. While shown as a percentage increase over historic averages for search volumes and conversions per day, with day zero being the day that the advertisements are aired, other presentations can be used, such as normalized to a general rating-point system.

The motorcycle manufacturer, as well as its competitors, may be interested in knowing that online search terms associated with the manufacturer, motorcycles, or types and categories thereof, will rise the next day and drop quickly thereafter. Based on this predicted success rate (predicted using search volume and conversions), many marketers would likely purchase preferences or advertisements during the window of one and two days after the offline advertisements aired. Further, marketers can make a highly cost-effective decision to purchase preferences, as they only last about two days.

As noted in part above, predicting success rates can be performed prior to or after commencing the offline advertisements in the offline advertisement schedule. If predictions are made after commencing the offline advertisements, the predictions can be performed prior to after completing the ads for the offline advertisement schedule.

While predictor 210 is show predicting different success rates for different days of a multi-day time period, exact specificity as to days or hours is not necessarily required. Predictor 210 can also determine financial values for the online search terms for various times based on predicted success rates, which is described in greater detail as part of methods 700 below.

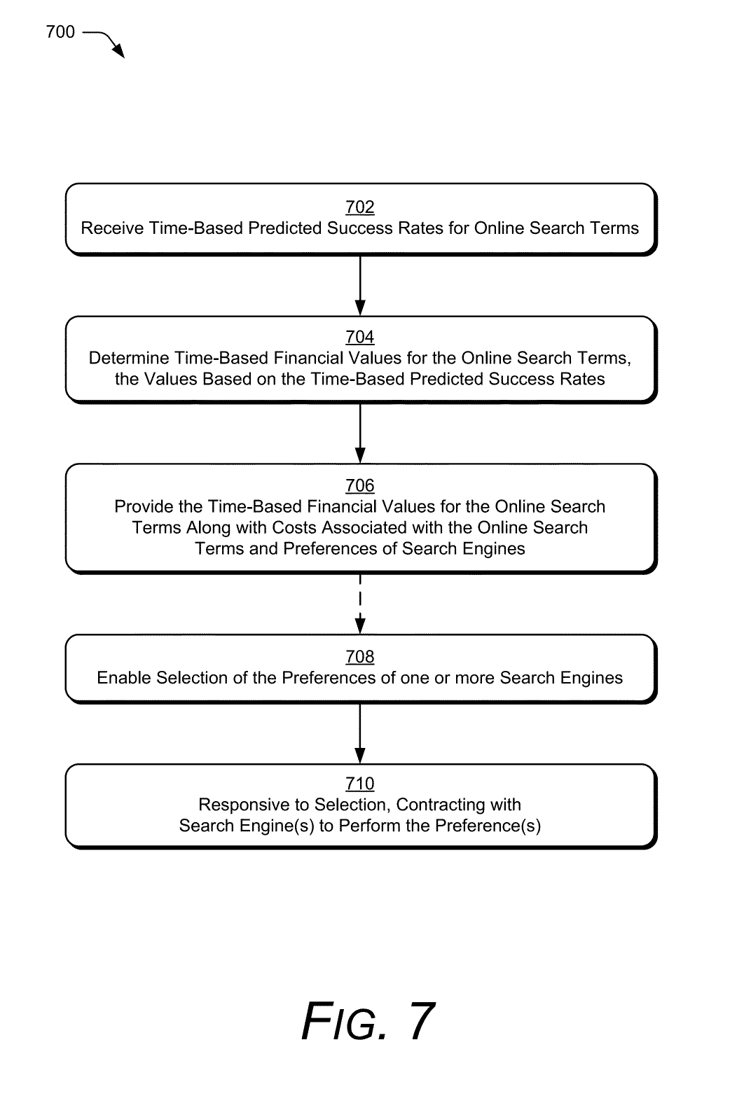

FIG. 7 depicts methods 700 in an example in which the techniques use time-based predicted success rates for online search terms to determine time-based financial values for the online search terms.

Block 702 receives time-based predicted success rates for the online search terms, the time-based predicted success rates based on an offline advertising schedule for a product, brand, or entity associated with the online search terms. The time-based predicted success rates, as noted above, can be one or more of a predicted search volume, click-through rate, or conversion rate or other data indicating some form of success.

These success rates can be provided by, and method 700 can work in conjunction with, methods 400. Thus, predictor 210 may receive histogram 604 of FIG. 6 or data used to build histogram 604.

Block 704 determines time-based financial values for the online search terms, the values determined based on the time-based predicted success rates. Predictor 210, as noted above, can determine which online search terms are of interest, and various manners in which to predict success. Financial values can be based on predicted search volumes, click-through rates, and conversion rates, together or separately, and with varying financial vales associated with each. Determining the time-based financial values for the online search terms can be for a similar, same, or related product, brand, or entity to the product, brand, or entity of the offline advertising schedule though the financial values may be higher or lower than historic averages based on the offline advertising schedule.

Consider, for example, a case where an offline advertising schedule is for a new novel directed at teenagers. Assume that this offline advertising schedule combines various types of offline advertising occurring over six weeks: for all of weeks 1-6, billboard advertisements are used; for weeks 3-6, brick-and-mortar books stores put up large signs and so forth in and around their stores; for weeks 5 and 6, television commercials are aired during program directed at teenagers and mothers of teenagers; for week 6 radio ads are aired; and for the last day of week 6, the brick-and-mortar stores stay open until midnight for early sales of the books, which is also a form of offline advertising.

For this example offline advertising schedule, predictor 210 may determine, either during or in advance of the ads being placed, success rates and financial values of online search terms associated with the novel. This can be fairly complex, such as search volumes predicted to be high at weeks 5 and 6 based on the television commercials, but conversion rates (e.g., online advance sales for the novel) being highest in weeks 3 and 4, and click-through rates being high at weeks 1-4 but dropping when the television ads begin (e.g., because the website being clicked just showed the television advertisement earlier). Predictor 210, through user interface 112, may present predicted financial values for each day in the six weeks and thereafter, which may factor in differing ways in which to predict success rates and valuing each, such as a highest value placed on predicted conversions and a lowest value on search volume, and so forth. This detailed information can be valuable to marketers determining how best to spend resources on offline advertisements (as a feedback to offline ad costs) and preferences for search engines.

Furthermore, note that predicted success rates and financial values can be negative relative to historic success rates. The example teen novel advertisements, for example, can negatively affect other teen novels, movies competing for teen entertainment, and teen clothing competing for limited funds.

Block 706 provides the time-based financial values for the online search terms along with costs associated with the online search terms, the costs associated with preferences by search engines through which a search using the online search terms can be performed. Predictor 210, based on the timing of predicted success rates (e.g., hourly, daily, weekly), can vary success rates over time and their values to maximize a success-rate-to-cost ratio over a period of time. By so doing, marketers may better assess whether or not to pay for preferences and if so, when to do so.

Alternatively, methods 700 may proceed to blocks 708 and 710. Block 708 enables selection, though the user interface, of the preferences by the search engines. Responsive to selection of the preferences, block 710 contracts with or otherwise acquires preferences to be performed by the search engines. Thus, predictor 210, through user interface 112, can handle bids for one or multiples of the search engines for the online search terms. In some optional cases, user interface 112 presents predicted values per day, costs per day associated with each search engine, enables selection of preferences, and then, on selection handles paying the search engines for the preferences. By so doing, the techniques enable an efficient system for marketers to understand values for, and select preferences for, online search terms based on offline advertising schedules.

### Example System and Device

FIG. 8 illustrates an example system generally at 800 that includes an example computing device 802, which is representative of one or more computing systems and/or devices that may implement the various techniques described herein. This is illustrated through inclusion of predictor 210, which may be configured to predict success rates for online advertisements and/or search terms based on offline advertising. Computing device 802 may be, for example, a server of a service provider, a device associated with a client (e.g., a client device), an on-chip system, and/or any other suitable computing device or computing system.

Computing device 802 as illustrated includes a processing system 804, one or more computer-readable media 806, and one or more I/O interface 808 that are communicatively coupled, one to another. Although not shown, computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

Processing system 804 is representative of functionality to perform one or more operations using hardware. Accordingly, processing system 804 is illustrated as including hardware element 810, which may be configured as processors, functional blocks, and so forth. This may include implementation in hardware as an application-specific integrated circuit or other logic device formed using one or more semiconductors. Hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

Computer-readable storage media 806 is illustrated as including memory/storage 812. Memory/storage 812 represents memory/storage capacity associated with one or more computer-readable media. Memory/storage 812 may include volatile media (such as random access memory (RAM)) and/or nonvolatile media (such as read only memory (ROM), Flash memory, optical disks, magnetic disks, and so forth). Memory/storage 812 may include fixed media (e.g., RAM, ROM, a fixed hard drive, and so on) as well as removable media (e.g., Flash memory, a removable hard drive, an optical disc, and so forth). Computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The entities described herein (e.g., predictor 210 and user interface 112) generally represent software, firmware, hardware, or a combination thereof. The features of the techniques described herein are platform-independent, meaning that the techniques may be implemented on a variety of commercial computing platforms having a variety of processors.

An implementation of the described entities and techniques may be stored on or transmitted across some form of computer-readable media. The computer-readable media may include a variety of media that may be accessed by computing device 802. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. Computing device 802 may be configured to implement particular instructions and/or functions corresponding to the software and/or hardware modules. Accordingly, implementation of a module that is executable by computing device 802 as software may be achieved at least partially in hardware, e.g., through use of computer-readable storage media and/or hardware elements 810 of processing system 804. The instructions and/or functions may be executable/operable by one or more articles of manufacture (for example, one or more computing devices 802 and/or processing systems 804) to implement techniques, modules, and examples described herein.

The techniques described herein may be supported by various configurations of computing device 802 and are not limited to the specific examples of the techniques described herein. This functionality may also be implemented all or in part through use of a distributed system, such as over a “cloud” 814 via a platform 816 as described below.

Cloud 814 includes and/or is representative of platform 816 for resources 818. Platform 816 abstracts underlying functionality of hardware (e.g., servers) and software resources of cloud 814. Resources 818 may include applications and/or data that can be utilized while computer processing is executed on servers that are remote from computing device 802. Resources 818 can also include services provided over the Internet and/or through a subscriber network, such as a cellular or Wi-Fi network.

Platform 816 may abstract resources and functions to connect computing device 802 with other computing devices. Platform 816 may also serve to abstract scaling of resources to provide a corresponding level of scale to encountered demand for resources 818 that are implemented via platform 816. Accordingly, in an interconnected device embodiment, implementation of functionality described herein may be distributed throughout system 800. For example, the functionality may be implemented in part on computing device 802 as well as via platform 816 that abstracts the functionality of cloud 814.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving an offline advertising schedule for a product, brand, or entity;
predicting, based on the offline advertising schedule, success rates for online advertisements or online search terms associated with a same, similar, or related product, brand, or entity; and
providing the predicted success rates for the online advertisements or online search terms, respectively.

2. A method as described in claim 1, wherein the offline advertising schedule is for a first product having a first brand and made by a first entity and the predicting success rates for online advertisements or online search terms predicts success rates for a second product having a second brand and made by a second entity, the predicted success rates based on a similarity of the first product to the second product, the first brand to the second brand, or the first entity to the second entity.

3. A method as described in claim 1, wherein the predicted success rates for the online advertisements or online search terms is for the online search terms and includes a search volume, click-through rate, or conversion rate.

4. A method as described in claim 1, wherein receiving the offline advertising schedule retrieves the offline advertising schedule from a third-party market-research company.

5. A method as described in claim 1, further comprising normalizing the offline advertising schedule using offline advertising ratings data, and wherein predicting success rates is based on the normalized, offline advertising schedule.

6. A method as described in claim 1, wherein predicting success rates is based on a timing, repetition, or number of persons expected to be exposed to advertisements of the offline advertising schedule.

7. A method as described in claim 1, wherein predicting success rates is further based on historic success rates for historic offline advertising schedules.

8. A method as described in claim 1, where predicting success rates predicts different success rates for different days of a multi-day time period.

9. A method as described in claim 8, further comprising determining financial values for the online search terms, the determining financial values determining different financial values for the online search terms for each of the different days.

10. A method as described in claim 1, wherein the predicted success rates for the online advertisements or online search terms is for the online advertisements and includes a click-through rate or a conversion rate.

11. A method as described in claim 1, wherein predicting success rates is performed after commencing advertisements in the offline advertising schedule but prior to completing the advertisements in the offline advertising schedule.

12. A method as described in claim 1, further comprising determining the online search terms associated with the product, brand, or entity of the offline advertising schedule.

13. A method as described in claim 1, wherein the offline advertising schedule indicates advertisements being concentrated in a particular geographic location, cultural group, or politically-bounded region and wherein predicting success rates predicts success rates for the geographic location, the cultural group, or the politically-bounded region.

14. One or more computer-readable storage media comprising instructions that are stored thereon that, responsive to execution by a computing device, causes the computing device to perform operations comprising:
receiving time-based predicted success rates for online search terms, the time-based predicted success rates based on an offline advertising schedule for a product, brand, or entity associated with the online search terms;
determining time-based financial values for the online search terms, the time-based financial values determined based on the time-based predicted success rates; and
providing the time-based financial values for the online search terms along with costs associated with acquiring preferences by search engines through which a search using the online search terms can be performed.

15. One or more computer-readable storage media as described in claim 14, wherein the time-based predicted success rates are based at least on a predicted conversion rate.

16. One or more computer-readable storage media as described in claim 14, wherein the time-based predicted success rates are based at least on a predicted click-through rate.

17. One or more computer-readable storage media as described in claim 14, further comprising enabling selection, though a user interface, of the preferences by the search engines, and, responsive to selection of the preferences, contracting with the search engines to perform the preferences.

18. One or more computer-readable storage media as described in claim 14, wherein the time-based financial values include a maximum success-rate-to-cost ratio over a period of time.

19. One or more computer-readable storage media as described in claim 14, wherein determining the time-based financial values for the online search terms is for a similar product, brand, or entity to the product, brand, or entity of the offline advertising schedule.

20. A system comprising:
one or more computer processors;
one or more computer-readable storage media comprising instructions stored thereon that, responsive to execution by the one or more computer processors, causes the computer processors to perform operations comprising:
receiving an offline advertising schedule for a product, brand, or entity;
predicting, based on the offline advertising schedule, success rates for online search terms associated with a same, similar, or related product, brand, or entity;
determining time-based financial values for the online search terms, the values determined based on the predicted success rates; and
providing the time-based financial values for the online search terms along with costs associated with the online search terms, the costs associated with preferences by search engines through which a search using the online search terms can be performed.
